(19) United States
(12) Patent Application Publication
(10) Pub. No.: US 2009/0089205 A1
(43) Pub. Date: Apr. 2, 2009

(54) AUTOMATED QUALIFYING OF A CUSTOMER TO RECEIVE A CASH LOAN AT AN AUTOMATED TELLER MACHINE

(76) Inventor: Anthony Jeremiah Bayne, Lomita, CA (US)

Correspondence Address: ANTHONY JEREMIAH BAYNE, 25315 ANDREO AVENUE, LOMITA, CA, 90717, US

(21) Appl. No.: 11/871,992

(22) Filed: Oct. 13, 2007

Related U.S. Application Data
(60) Provisional application No. 60/976,429, filed on Sep. 29, 2007.

(51) Int. Cl. G06Q 40/00

(52) U.S. Cl. 705/38; 705/43; 705/35

(57) ABSTRACT

An automated system and method for qualifying a customer to receive a cash loan at an ATM, when the customer attempts to withdraw more than the available cash from an account that receives regular deposits, and selecting a fee to charge for overdraft protection on a transactional basis. The fee amount is selected from a range of fees, and is dependent on the amount of overdraft protection provided, as a percentage of the transaction amount.

### RELATED APPLICATION

The present application claims priority of provisional patent application 60/976,429 filed on Sep. 29, 2007, and hereby incorporates it by reference, as if fully reinstated herein.

### BACKGROUND OF THE INVENTION

1. Field of Invention

The present invention relates to systems and methods for marketing a cash loan. More specifically, the invention relates to an automated qualifying of a customer to receive a cash loan at an automated teller machine (ATM), when the customer attempts to withdraw more than the available cash from an account that receives regular deposits.

2. Description of Related Technology

Many persons are employed, and regularly have their paychecks directly deposited into their checking accounts. Sometimes an employee may fail to record a transaction in his account ledger. This may result in a failed attempt to withdraw a selected amount of cash at an ATM, when the selected amount exceeds the account's available cash.

Further, while the employee may be able to get a short term cash loan from a “payday loan” business, the employee may not want to spend the time it takes to fill out a loan application, submit a post-dated check, or pay the fees and interest associated with such a loan.

Therefore remains a need for financial institutions to provide an automated means of qualifying a customer to receive a cash loan, at an ATM, when the customer seeks to withdraw more cash than the account's available cash.

Financial institutions (e.g. banks) offer financial services to customers that include overdraft protection, bounce protection, and overdraft transfer protection to prevent a customer's check from “bouncing” (i.e. being returned unpaid due to insufficient funds “NSF”), or having an ATM cash withdrawal refused, because the selected amount exceeds the account's available cash. These services can provide the difference in funds to successfully complete a check or ATM transaction.

The fee charged for the service(s) is usually less than the combined charges (NSF fee+returned check fee) a customer may be charged if a check was allowed to bounce. In the absence of the aforesaid services, a customer who attempts to withdraw cash from an ATM that exceeds the available cash will have the withdrawal refused without a fee. A customer who writes a check against NSF will have the check bounce, resulting in charges from the customer's bank and the bank that attempted to cash the NSF check.

Overdraft protection is a line of credit established by contract between a bank and a customer. The bank promises to pay overdrafts up to a certain dollar limit, and the customer agrees to pay a fee(s) for the service. The customer completes and submits a credit application, after which the bank checks the customer's credit and approves or denies the application.

Under a bounce protection plan, a bank may choose to cover overdrawn items at their discretion and charge an overdraft fee, the amount of which may or may not be disclosed. Since the bank is not contractually obligated to cover the overdrafts, bounce protection is not regulated by the “Truth in Lending Act” that prohibits certain deceptive advertisements and requires disclosure of the terms of loans.

Under an overdraft transfer protection plan, a bank will transfer funds from “Account A” to cover a shortage of funds for a transaction in “Account B”. This service may be available to a customer who has two or more accounts (e.g. checking and savings) that are linked for this purpose and maintained by the same financial institution.

Notwithstanding the benefits of overdraft protection, bounce protection, and overdraft transfer protection (collectively “overdraft protection”), banks charge fees that are not based on how much credit was provided (the difference between available funds and the amount of the transaction), but rather on the fact that protection was provided. The result is that a customer will pay the same fee if an overdraft is $1.00 or $100.00. Further, the pay the “Biggest check first” policy of many banks often results in many smaller transactions triggering multiple overdraft fees.

Therefore remains a need for a bank offering overdraft protection to provide a range of fees that is commensurate with the amount of credit extended to make up a difference in funds, on a transactional basis.

In addition to banks, credit unions may provide financial services to its “members”, that are similar to the services provided by banks to their customers. Members are owners (shareholders) of the credit union, and the applicable laws, bylaws, and rules can differ from those that apply to a bank. For example, credit unions are non-profit financial institutions, and so are exempt from Federal and State income taxes.

A credit union may supply a member with overdraft protection on a share draft account. A member having a share draft account with overdraft protection may use an ATM to withdraw funds from the share draft account that exceeds the share draft account balance, resulting in a negative balance.

A member who is laid off or fired may move all funds at the credit union to a different financial institution, closing the credit union share draft account, or paying off any amount owed for overdraft protection.

Members who have direct payroll deposit often execute authorization forms for automatic payroll deduction that include language similar to the following:
“In the event of default under this or any other agreement, loan or account between the member and the credit union, the credit union may disregard the member's designation of distribution and apply any funds received under this agreement to any debt the member owes to the credit union, the amount and manner of such allocation and distribution to be within the sole discretion of the credit union.”

Under Section 107(11) of the FCU Act, 12 U.S.C., Section 14, Subchapter 1, subsection 1757(11) a credit union may enforce a statutory lien “to impress and enforce a lien upon the shares and dividends of any member, to the extent of any loan made to him and any dues or charges payable by him,” (emphasis added).

Notwithstanding the abovementioned authority, the credit union may not be able to take funds from other accounts of the member to offset any “overdraft” indebtedness, as the statutory lien has been applied only in the context of loans, and overdrawing an account does not constitute a “loan”.

Since a credit union's bylaws may give a member a lengthy time (e.g. 6 months) to raise a share balance back to par, the member has ample time to transfer funds from any other account at the credit union, before the credit union can terminate the account, recognize a “loss”, and attempt to collect overdraft charges. The may be an uncollectible loss. So, while a credit union can provide overdraft protection like a bank, it may be hindered by laws, rules, and by-laws unique to credit unions to collect a member's debts.

Therefore remains a need for a credit union to provide needed cash to its members, while enabling the credit union to use a statutory lien a member's other accounts to collect monies owed.

### BRIEF SUMMARY OF THE INVENTION

The present invention solves the above described problems and provides a distinct advance in the art of marketing a cash loan to a customer

In one embodiment, the invention provides for an automated method to qualify a customer to receive a cash loan at an ATM, when the customer attempts to withdraw more than the available cash from an account that regularly receives deposits.

In another embodiment, the invention provides for an automated system to qualify a customer to receive a cash loan at an ATM, when the customer attempts to withdraw more than the available cash from an account that regularly receives deposits.

In another embodiment, the invention provides for an automated method to qualify a member to receive a cash loan at an ATM, when the member attempts to withdraw more than the available cash from a share draft account that regularly receives deposits.

In another embodiment, the invention provides for a method to select an overdraft fee, on a transactional basis, that varies according to the amount of credit provided to complete a transaction, as a percentage of the transaction.

Other aspects and advantages of the present invention will be apparent from the following detailed description of the preferred embodiments and the accompanying drawing figures.

### BRIEF DESCRIPTIONS OF DRAWINGS

FIG. 1 is a block diagram illustrating an exemplary system in accordance with certain embodiments of the present invention.

FIG. 2 depicts a high level flow diagram illustrating the preferred method of the present invention.

FIG. 3 depicts a high level flow diagram illustrating the preferred method of the present invention in determining an overdraft fee on a transactional basis

### DETAILED DESCRIPTION DRAWINGS

The various features and methods of the invention will now be described in reference to the drawings in which the various elements of the present invention will be given numeral designations and in which the invention will be discussed so as to enable one skilled in the art to make and use the invention. It is to be understood that the following description is only exemplary of the principles of the present invention, and should not be viewed as narrowing the claims.

The present invention provides specialized cash loan processing systems and methods for qualifying a customer to receive a cash loan while at an ATM. An ATM may be configured to connect with a cash loan processing system, to provide cash to a customer when the customer attempts to withdraw more cash, than the available cash, from an account that regularly receives deposits. Interest, and other fees may be charged to the customer's account, once the customer accepts the loan terms presented and a cash loan is disbursed from the ATM.

In accordance with one aspect of the present invention, there is provided a truncated loan process technique that advantageously employs the regularity of deposits made to a customer's account as data to assess the level of financial risk of a particular customer account holder, in determining whether the customer qualifies for a cash loan.

Although the following description of exemplary embodiments will be described in the context of a retail bank (e.g. Bank of America) qualifying, offering, and making a cash loan to an individual customer having an account that regularly receives deposits, it should be understood the invention may also be applicable in other embodiments to other financial institutions that lend to customers. Thus, the term “bank” as used herein should be broadly construed to encompass any bank, credit union, brokerage, trust, or other financial institution. Likewise, the term “account” should be broadly construed to encompass any account capable of regularly receiving deposits. Further, the term “customer” should be broadly construed to encompass anyone (e.g. individual, corporation, trust, etc.) that may have ATM access to an account.

It should be understood that as used herein, “available cash” is the balance of a customer's account, without considering any credit line, linked account, or overdraft protection that may be available to the customer, or associated with the customer's account. Further “available cash” is to be distinguished from a “maximum cash withdrawal limit” set by a bank for ATM cash withdrawals. ATM's, associated databases, and processing modules are well known to those skilled in the art, and so are not described further herein.

The present invention may be used by participating banks to enroll new customers and reduce customer attrition. For example, by providing a range of overdraft protection fees for overdraft protection, based on the amount of credit extended on a transactional basis, a bank may be perceived as being more “fair” than other banks that employ a “one size fits all” approach to charging overdraft fees.

The present invention may be also used by participating credit unions to shorten the time needed in obtaining a security lien against a member's other credit union accounts, before a member move them to a different financial institution.

A customer at an ATM, presenting an access card, enters the correct access code, to his/her checking account. The customer selects “withdraw” from “checking”, and a cash amount. When the customer selects an amount that exceeds the account's available cash, the method uses the difference between the selected amount and available cash, as indicia that the customer could use a loan an automated determination is made of whether the customer qualifies for a cash loan.

In an alternate embodiment, the method may attempt to qualify and offer a customer a loan even when the selected cash withdrawal amount is less than the account's available cash, if the withdrawal would cause the account balance to fall below a certain dollar threshold (e.g. under $100.00). In this way, the method provides a means for a customer to avoid becoming overdrawn

In a preferred embodiment, a customer will qualify for a loan, if the customer's account regularly receives deposits (e.g. direct payroll deposits). If the customer's account does not, the customer is advised that the amount selected exceeds the account's available cash, and the withdrawal request for the amount selected is denied. The customer may make another selection, or have the card returned.

If the customer qualifies for a cash loan, the customer is notified graphically on the ATM screen or audibly, that he may receive a cash loan at the ATM subject to terms. The customer is prompted to choose to learn more, select another transaction, or return the card. If the customer chooses to learn more, terms complying with the Truth in Lending Act are presented. A further term includes the customer agreeing that any loan, fees and interest may be deducted from any deposit made to a customer account maintained by the bank, as allowed by law.

The customer may reject the terms, by selecting a “reject” icon, requesting the return of the card, or choosing another transaction. The customer who chooses to accept the terms may be prompted to accept by selecting an “accept” icon, inputting an answer to a question relating to the personal information of the account holder (e.g. DOB), or re-inputting the access code, before a cash loan is granted and distributed from the ATM. The customer may be denied a loan if the access code cannot be authenticated after a set number of attempts, or if the requested information is not entered after being prompted to do so.

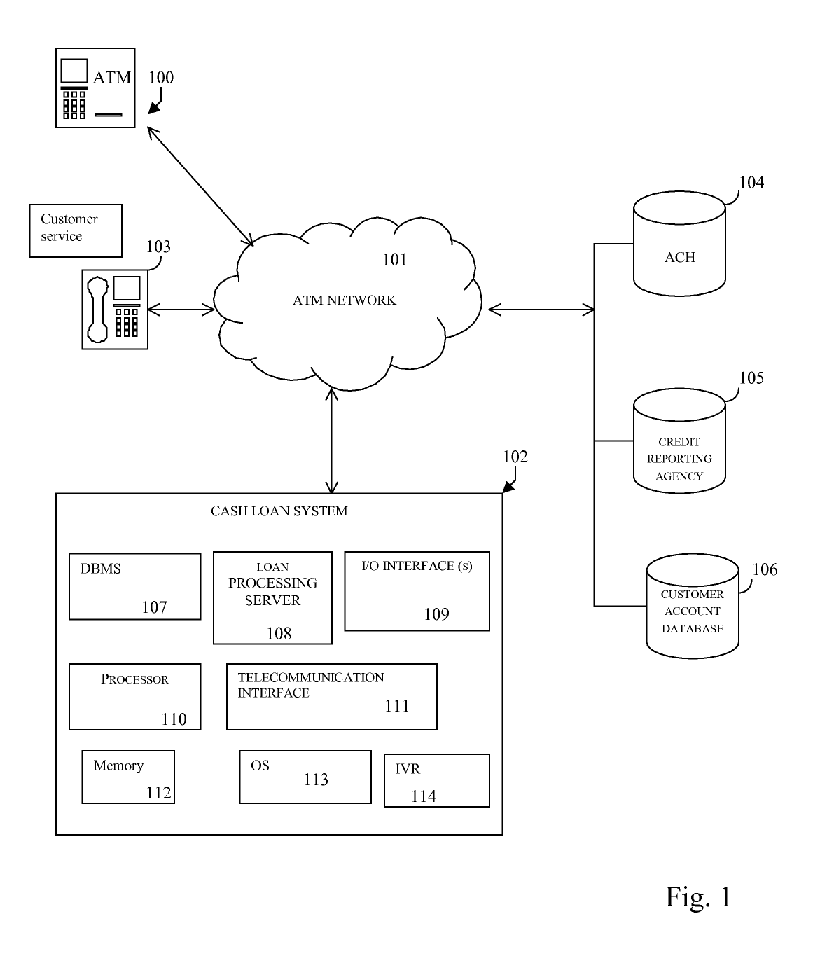

Exemplary embodiments of the present invention will hereinafter be described with reference to the figures, in which like numerals indicate like elements throughout the several drawings. FIG. 1 is a block diagram illustrating an exemplary operating environment for implementation of certain embodiments of the present invention. The exemplary operating environment includes at least one ATM 100 that is connected to a cash loan system (CLS) 102, an automated clearing house (ACH) 104, at least one external credit reporting agency 105, a customer service center 103, and a customer account database 106. An ATM network 101 connects the ATM 100, the CLS 102, ACH 104, credit reporting agency 105, customer service center 103, and customer account database 106.

The ATM network 101 may be any public and/or private communication network. In certain embodiments, the ATM network 101 is the Public Switched Telephone Network (PSTN). The ATM network 101 may include wired and/or wireless segments and may carry digital and/or analog signals. In alternate embodiments, the ATM network 101 may take other forms, such as a voice over IP network or other type of data network. The various components and functionality of typical ATM networks 101 are well known in the art and are therefore not reiterated herein.

The ATM 100 may be any traditional ATM or other communication device capable of dispensing cash that is configured to interact with the CLS 102. In other embodiments, an ATM 100 could be replaced or supplemented by other communication devices, such as a cash register with debit card reader, etc., as may be appropriate.

The CLS 102 is contemplated as being a processor-driven device or collection of devices, that is configured for receiving and processing loans, as well as calculating overdraft fees on a transactional basis. The CLS 102 may further be configured for accessing and reading associated computer-readable media having stored thereon data and/or computer-executable instructions for implementing the various methods of the present invention. In particular, the CLS 102 may be driven by a processor 110 for processing data and executing computer-executable instructions, including determining whether a customer qualifies for a cash loan, and what overdraft fee to charge a customer. The CLS 102 also includes a memory 112, which may take the form of any computer-readable medium. The memory 112 may be logically and/or physically divided into multiple units.

The memory 112 stores data and program modules, such as, for example, an operating system (“OS”) 113, a database management system (“DBMS”) 107, and an Interactive Voice Response (“IVR”) module 114. These and/or other program may be executed by the CLS 102 to perform the various methods of the present invention. By way of example, the IVR module 114 may provide functionality for responding to voice or other responses, such as Touch Tones, provided by a customer to the CLS 102 via the ATM 100.

IVR functionality is well known in the art and is therefore not explained in detail herein. Those skilled in the art will appreciate that such functionality may be combined into fewer program modules or distributed among a greater number of modules than are illustrated in FIG. 1. In addition, such functionality may be distributed across multiple processor-driven devices, such as dedicated network servers, that collectively form the CLS 102.

The CLS 102 may include or be in communication with one or more databases. By way of illustration only, the CLS 102 may be in communication with an ACH 104 for depositing loan proceeds to the customer's bank account, a customer account database 106 that contains customer account information, and a credit reporting agency 105 for supplying a customer's credit score if requested by the CLS 102.

These and/or other databases may of course also store any other data used or generated by the CLS 102. Those skilled in the art will appreciate that the illustrated databases 104-106 may be physically and/or logically separate from one another. For security, the CLS 102 may have a dedicated connection to the ATM 100 and databases 104-106. However, the CLS 102 may also communicate with one or more of the databases 104-106 via the ATM network 101, or other network, as shown.

The ATM 100 transmits information that may be received at the CLS 102 through a telecommunication interface 111. The telecommunication interface 111 may take the form of a telephony line card or other suitable hardware and/or software for connecting the CLS 102 to the ATM 100 via the ATM network 101 and providing the logical connection between the CLS 102, customer service center 103 and outside databases 104-106. The telecommunication interface 111 thus allows the customer to interact with the CLS 102 by providing Touch-Tone commands or voice commands at the ATM 100 that can be interpreted by the IVR module 114 and/or other program modules. The CLS 102 may be configured with additional and/or other communication interfaces for providing logical connections to other types of communication devices and networks.

The CLS 102 may also include input/output (“I/O”) interface(s) 109 for providing logical connections to various I/O devices, such as a keyboard, a mouse, a microphone, a printer, a scanner, speakers, a display, etc. A system administrator may utilize these and other I/O devices to interact with the CLS 102. For example, a system administrator may interact with the CLS 102 to populate and edit the customer account database 106, alter the overdraft fee parameters for the loan processing server 108, and other program modules, etc. Those skilled in the art will appreciate that the CLS 102 may include alternate and/or additional components, hardware or software.

Thus configured or similarly configured, the CLS 102 may provide a cash loan to a qualifying customer, via an ATM 100, when the CLS 102 is programmed to interact with a customer using the ATM 100.

When a customer at an ATM 100 attempts to withdraw more cash than the account's available cash, the CLS 102, in order to determine if the customer qualifies for a loan, may query the customer account database 106 to acquire the customer's account history, including whether regular deposits are made to the account,. The loan process server 118 may also be programmed to present a notice of loan qualification to the customer if the customer qualifies for a loan. Other terms and conditions for receiving a loan, and use of the services provided by the CLS 102 may be graphically presented, for example on a graphical interface of the ATM 100 (not shown), or audibly presented to the customer by the IVR module 118. If the customer has a question about a loan term, the CLS 102 may connect the customer to a customer service representative at a customer service center 103, to insure the customer is fully advised before accepting any loan offer.

The CLS 102, as an example, may prompt the customer to indicate whether he or she will accept the terms presented. Terms will comply with the “Truth in Lending Act”, and that the bank may collect repayment from any deposit made to any customer account maintained by the bank as allowed by law.

A customer at an ATM 100 that is linked to the CLS 102 may be prompted to choose whether he or she desires to accept the loan terms presented. By way of example, the loan process server 118 may prompt the customer to accept the terms by re-inputting the access code associated with the account.

When the customer provides a valid access code, or other requested information, the CLS 102 may distribute a cash loan to the customer at the ATM 100. In this manner, a cash loan is made to the customer. Other methods for issuing cash or its functional equivalent are known in the art and are contemplated herein. For instance, when the ATM access card is also a stored value card, the loan process server 118 may be programmed to give the customer an option of loading the stored value card with credit at the ATM 100, instead of distributing cash. In the preferred embodiments, all loan processing and verification services involving the customer are handled by the CLS 102, for example by a participating bank.

Those skilled in the art will appreciate that the operating environment shown in and described with respect to FIG. 1 is provided by way of example only. Numerous other operating environments, system architectures and device configurations are possible. For example, the CLS 102 may in certain embodiments be implemented at or within the ATM 100. In other embodiments, various components of the ATM network 101 may be adapted for performing the functionally described with respect to the present invention. Accordingly, the present invention should not be construed as being limited to any particular operating environment, system architecture or device configuration.

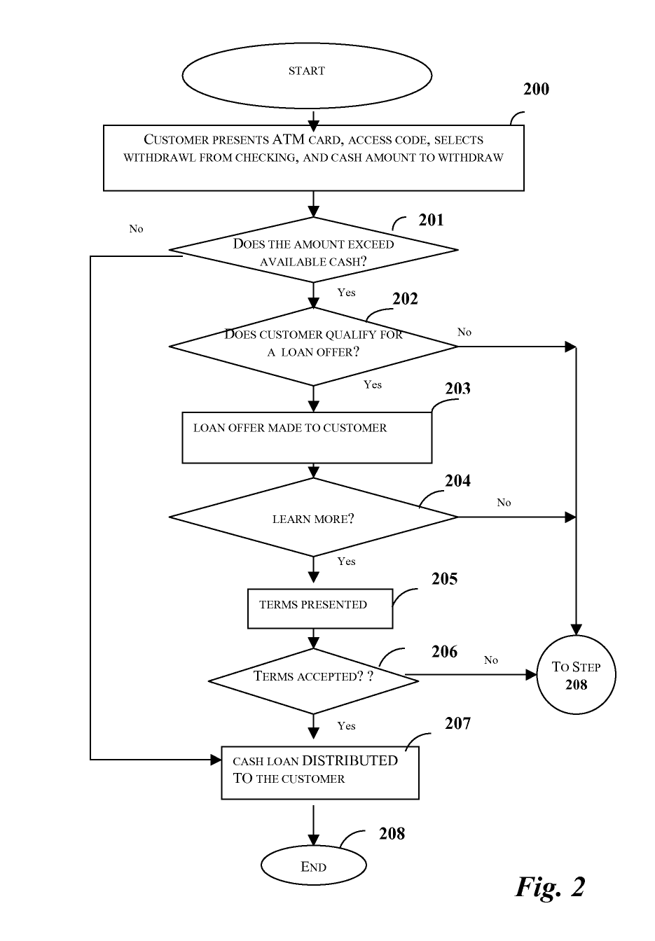

FIG. 2 illustrates, in accordance with an exemplary embodiment of the present invention, the automated qualifying of a customer for a cash loan. The first step 200 of the loan process is a customer accessing his/her checking account via the ATM 100 to withdraw cash. The customer presents an access card, inputs the correct access code, selects “withdrawal” from “checking”, and selects an amount of cash for withdrawal.

Once the customer selects an amount to withdraw, the method proceeds to step 201 where it is determined if the selected amount exceeds the account's available cash. In a preferred embodiment, if the selected amount does not exceed the available cash, the method proceeds to step 207 where the ATM distributes the amount selected and the method ends.

In an alternate embodiment, the method may attempt to qualify a customer for a loan even when the selected amount is less than the account's available cash, when the withdrawal of the amount selected would reduce the account balance under a dollar threshold amount (e.g. under $100.00). In this embodiment, the method provides a means for a customer to avoid his/her account becoming overdrawn.

If the customer selects an amount that exceeds the account's available cash, the method proceeds to step 202 where it is determined by the CLS 102 whether the customer qualifies for a loan. In a preferred embodiment, a customer will qualify for a loan if the customer's accessed account receives regular, direct payroll deposits. For example, the CLS 102 may query the customer account database 106 to determine whether the customer's account history shows that the account has received at least 7 direct deposits, in repeating time increments (e.g. weekly, bimonthly, etc.) from a single source (e.g. State of California) before qualifying the customer to receive a loan. Further, by using information that may reside in the bank's CLS 102, a loan evaluation can be done quickly and without the bank paying outside service fees to a secondary information provider (e.g. Experian).

In alternate embodiments, in addition to, or instead of an account receiving a number of direct deposits, a customer may qualify for a loan if the customer regularly makes deposits over the counter, or through an ATM, thereby demonstrating that the customer has a regular source of income. For example, it may be acceptable that the customer himself has regularly deposited a check into the account on or about the 1^{st} and 15^{th} of each month, for the past year.

The CLS 102 may alternatively employ other factors, alone or in combination with others, to evidence a likelihood of future deposits, to qualify a customer for a loan.

In an alternative embodiment, the method may qualify a customer for a loan based on the timing of the attempted withdrawal. For example, the method may qualify a customer for a loan, if based on a pattern of regular deposits, the attempted ATM cash withdrawal occurs shortly before the next estimated deposit. In this way, there is less time for checks to be written that may interfere with any loan collection.

In another embodiment, a customer may qualify for a loan if the difference between the amount selected for withdrawal and the account's available cash is less than a certain amount (e.g. <$40.00) and there is no account history indicating that the customer is a potential credit risk (e.g. no checks returned unpaid in the last year).

If the CLS 102 determines that the customer does not qualify for a loan, the method proceeds to step 208 where the customer is informed at the ATM 100 through a graphical interface (not shown) that the amount selected exceeds the account's available cash, and ends.

If the customer qualifies for a loan, the method proceeds to step 203 where the CLS 102 notifies the customer, via the ATM 100, that the customer qualifies for a loan. This notice is preferably done via an ATM 100 graphical interface. In some embodiments the customer may be presented with an option to select a language other than English, or have the notice “read” by the IVR 114, via the ATM 100 equipped with a speaker or earphone jack.

The loan amount offered is preferably limited to the difference between available cash and the amount selected for withdrawal (up to the daily maximum cash withdraw limit set by the bank). In this way the risk is limited to the daily maximum cash withdraw limit.

The method then proceeds to step 204, where the CLS 102 receives the customer responses made via the ATM 100 and determines if the customer is interested in learning more about receiving a loan. If the customer is not interested in learning more, the method proceeds to step 208 where the customer is informed that the amount selected exceeds the account's available cash, and ends.

If the CLS 102 determines that the customer is interested in learning more, the method proceeds to step 205 where the loan terms are presented to the customer via an ATM 100 graphical interface. In some embodiments, the customer may be presented with an option to select a language other than English, or have the terms “read” by the IVR 114 via the ATM 100, equipped with a speaker or earphone jack. In some embodiments the ATM 100 may be equipped with a phone that is linked to a representative at a customer service center 103 to explain the terms if necessary.

The method then proceeds to step 206 where the CLS 102 determines if the customer accepts or rejects the terms. In a preferred embodiment, to keep the repayment term short, in addition to terms complying with the Truth in Lending Act, terms may include that the bank receive priority in deducting the total cost of the loan (e.g. principal, interest, fees, commissions, etc.) from any deposit made into any account held by the customer at the bank. In an alternate embodiment, the customer may be given the option to have the total cost of the loan deducted against two or more deposits.

The customer may be prompted to acknowledge that he understands and accepts the terms by re-inputting his access code or other identifier (e.g. zip code) associated with the account into the ATM 100. If the customer rejects the terms, or does not respond within a specific time set by the bank, the method proceeds to step 208 where the customer is informed the amount selected exceeds the account's available cash and ends.

If it is determined by the CLS 102 that the customer accepts the terms, the method proceeds to step 207 where a cash loan is made to the customer. In an alternate embodiment, where the customer's access card is also a stored value card (e.g. debit card) the method may allow the customer to select that the loan amount be added to the card already inserted into the ATM 100. In some embodiments the customer may choose to have the ATM 100 print out a copy of the loan terms from the aperture that receipts come from, or have a copy of the terms emailed/mailed to an email address/address associated with the customer's account.

In a preferred embodiment the amount to be loaned is the difference between the amount selected for withdrawal and the account's available cash (up to the maximum daily cash withdraw limit set by the bank). In an alternate embodiment the amount of cash to be loaned is in an amount equal to the amount selected for withdrawal (up to the maximum cash withdraw limit set by the bank).

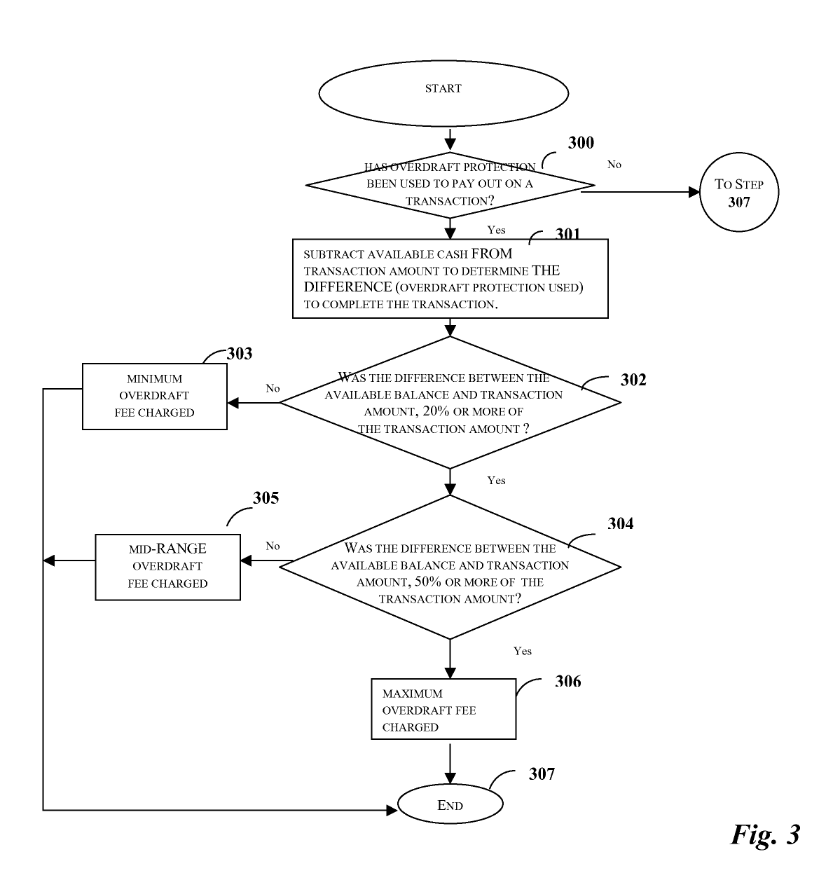

FIG. 3 illustrates, in accordance with an exemplary embodiment of the present invention, the determining of an overdraft fee, on a transactional basis. In a preferred embodiment this is done in real time, but alternatively could be done at the end of a statement cycle (e.g. monthly). As used herein, “overdraft protection” includes overdraft protection, bounce check protection, and overdraft transfer protection. “Paying out” on a customer's transaction means adding funds to a customer's account to prevent a customer's check being returned because of insufficient funds, preventing a denial of a customer's cash withdrawal transaction, and preventing a denial of a customer's debit transaction for lack of available funds.

In a preferred embodiment, the method determines what percent of the transaction amount (i.e. the total amount of a check, debit or cash withdrawal) was made up of overdraft protection, and uses that percentage in selecting what overdraft fee, in a range of fees, to charge. Alternatively, the account's available balance, as a percentage of the transaction, could be used to select what fee to charge.

The first step 300 of the overdraft fee selection process is the determining that overdraft protection is paid out on a customer transaction. The CLS 102 queries the customer account database 106 regularly to make this determination. If it determined that overdraft protection has not been used, the method proceeds to step 307 and ends. If it is determined that overdraft protection has been used, the method proceeds to step 301, where the CLS 102 determines the difference between the transaction and the available cash on a specific date. The date used may be the transaction date, settlement date, or other date, as specified in the bank's overdraft protection policy, or overdraft protection agreement with the customer.

By way of example, a customer withdraws $100.00 from his checking account when the account's available cash is only $40.00, triggering overdraft protection, as determined by the CLS 102. The Loan Processing Server 108 queries the customer account database 106 to gather customer's account transaction information. By subtracting the account's available cash of $40.00 from the transaction ($100) the Loan Processing Server 108 arrives at a difference of $60.00 at the time the withdrawal. The $60.00 difference is equal to the amount of overdraft protection provided to complete the transaction.

The method then proceeds to step 302 where the CLS 102, using parameters stored in the Loan Processing Server 108, determines if the difference (i.e. the amount of overdraft credit paid out to cover the transaction) made up 20% or more of the transaction amount. If the difference was not 20% or greater of the transaction amount, the method proceeds to step 303 where the minimum overdraft fee is selected to charge the customer's account, and the method proceeds to step 307 and ends. Continuing with the example, since is $60.00 is 60% of the $100 transaction, and so 20% or more of the transaction amount, the method proceeds to step 304.

At step 304, it is determined whether the difference is 50% or greater of the transaction amount. If the difference is less than 50% of the transaction amount, the method proceeds to step 305, where a mid-range overdraft fee is selected to charge the customer, and the method then proceeds to step 307 and ends.

Continuing with the example, since the difference was 60%, it makes up 50% or more of the $100.00 transaction amount. The method proceeds to step 306, where the method selects the maximum overdraft fee to charge the customer. In an alternate embodiment, the bank may choose a dollar amount instead of, or in addition to the aforesaid percentages. For instance, if a transaction amount is small (e.g. $20.00), a bank may choose a minimum overdraft fee to charge, even though more than 51% of the transaction consisted of overdraft protection.

In yet another alternate embodiment, a single overdraft fee (selected from a range of fees), multiplied by the number of transactions using overdraft protection during a statement cycle may be charged. For example, if a customer made 10 transactions requiring overdraft protection, and 2 would have resulted in a mid-range fee, but when averaged across the 10 transactions, averaged an overdraft that was less than 20% of the transaction amounts, the method may charge the minimum fee, times the 10 transactions.

As may be seen from the foregoing, the present invention provides systems and methods for providing a new revenue stream for participating financial institutions and benefits to the customer. The disclosed invention, in a preferred embodiment, uses the difference between a customer's available balance and the transaction amount, as a condition precedent to qualify a customer for a loan. This increases the probability that the bank will obtain new, low risk loan business from customer's with accounts that regularly receive deposits. Further, a credit union using the invention to provide cash via a “loan” instrument, instead of an “overdraft” instrument, will be able to use a statutory security lien more readily. Further, by providing a range of overdraft fees, based at least in part on the amount of credit extended as a percentage of the transaction, will assist in creating stronger relationships between the lender and customer.

It should be appreciated that the exemplary aspects and features of the present invention, as described above are not intended to be interpreted as required or essential elements of the invention, unless explicitly stated as such. It should also be appreciated that the foregoing description of exemplary embodiments was provided by way of illustration only and that many other modifications, features, embodiments and operating environments are possible. Accordingly, the scope of the present invention should be limited only by the claims that follow.

I claim:

1. A method for providing a customer a loan, via an ATM, comprising:
determining an amount of cash selected at an ATM for withdrawal from a customer's account;
determining the account's available cash for withdrawal;
determining whether the amount selected exceeds the account's available cash;
determining whether the customer qualifies to receive a loan, when the amount selected exceeds the available cash;
offering the customer a cash loan subject to terms, when the customer qualifies to receive a cash loan;
presenting loan terms to the customer, when the customer indicates an interest in receiving the cash loan;
determining if the customer accepts the terms presented; and
providing the cash loan to the customer, when the customer accepts the terms presented.

2. The method of claim 1, where a customer qualifies to receive a loan when the customer's account regularly receives deposits.

3. The method of claim 1, where a customer qualifies to receive a loan, when the customer has one or more accounts maintained by the loan offeror, that regularly receives deposits.

4. The method of claim 1, where the available cash is the customer's account balance, exclusive of any overdraft line of credit, bounce check protection, or overdraft transfer protection.

5. The method of claim 1, where a customer may select to have a credit added to a stored value card instead of receiving cash.

6. The method of claim 1, where loan terms comply with the Truth in Lending Act, and further includes a term that the loan, interest and fees may be deducted from any deposit made to any customer account maintained by the loan offeror.

7. The method of claim 1, where the customer accepts the loan terms presented by re-entering an ATM access code.

8. A system for providing a customer a loan, via an ATM, comprising:
means for determining an amount of cash selected at an ATM for withdrawal from a customer's account;
means for determining the account's available cash for withdrawal;
means for determining whether the amount selected exceeds the account's available cash;
means for determining whether the customer qualifies to receive a loan, when the amount selected exceeds the available cash;
means for offering the customer a cash loan subject to terms, when the customer qualifies to receive a cash loan;
means for presenting loan terms to the customer, when the customer indicates an interest in receiving the cash loan;
means for determining if the customer accepts the terms presented; and
means for providing the cash loan to the customer, when the customer accepts the terms presented.

9. The system of claim 8, further comprising means for qualifying a customer to receive a loan when the customer's account regularly receives deposits.

10. The system of claim 8, where the available cash is the customer's account balance, exclusive of any overdraft line of credit, bounce check protection, or overdraft transfer protection.

11. The system of claim 8, further comprises means for adding credit to an ATM access card, when the ATM access card is also a stored value card.

12. The system of claim 8, further comprising means for qualifying the customer based at least in part on the estimated time of the next deposit to the account, the estimate further based on a pattern of deposits made to the account.

13. A method for providing a loan, via an ATM, to a member of a credit union, comprising:
determining an amount selected by a member for withdrawal from the member's account via an ATM;
determining the available cash for withdrawal;
determining whether the amount selected exceeds the account's available cash;
determining whether the account regularly receives deposits, when the amount selected exceeds the available cash, further;
offering the member a cash loan subject to terms, when the account regularly receives deposits;
presenting loan terms to the member, when the member indicates that the member is interested in accepting the offer;
determining if the member accepts the terms presented; and
providing the cash loan to the member, when the member accepts the terms presented.

14. The method of claim 13, where regularly received deposits is comprised of a group consisting of, weekly, bi-monthly, monthly, quarterly, semi-annual, and annual deposits.

15. The method of claim 13, where the member agrees that loan repayment may be made by automatically deducting from any deposit made into any account maintained by the credit union for the member.

16. An automated method for determining an overdraft protection fee, on a transactional basis, comprising:
determining whether a customer's overdraft protection has paid out to cover a customer's transaction;
determining the difference between the transaction amount and available cash in the customer's account, when the overdraft protection has paid out to cover the transaction;
determining an overdraft protection fee for the transaction, based at least in part on the difference.

17. The method of claim 16, where an overdraft protection fee includes a range of overdraft protection fees.

18. The method of claim 16, where the range of overdraft protection fees, comprises a minimum fee, a mid-range fee and a maximum fee.

19. The method of claim 16, where determining the overdraft protection fee, further comprises determining the difference as a percentage of the transaction amount, and as the percentage increases the overdraft protection fee increases.

20. The method of claim 16, where the overdraft protection fee is based on the difference as a dollar amount, and increases as the difference in the dollar amount increases.

21. A method of marketing a loan to a customer via an ATM, comprising:
determining an amount selected by a customer to withdraw from the customer's account via an ATM;
determining whether the customer qualifies to receive a loan when the amount selected would reduce the account's available cash below a threshold amount; and offering a loan to the customer via the ATM, when the customer qualifies to receive a loan.

22. The method of claim 21, further comprising:
presenting loan terms to the customer;
determining whether the customer accepts the terms; and
providing the loan to the customer after the customer accepts the terms.

23. The method of claim 21, wherein the “available cash” is the customer's account balance, exclusive of any overdraft line of credit, bounce check protection, or overdraft transfer protection.

24. The method of claim 21, wherein the customer qualifies to receive a loan, when the customer's account regularly receives deposits.

25. The method of claim 21, wherein the customer accepts the loan terms presented by one of a group, the group comprising re-entering an ATM access code, answering a question relating to the personal information of the account holder.
